(19) United States
(12) Patent Application Publication
(10) Pub. No.: US 2009/0125591 A1
(43) Pub. Date: May 14, 2009

(54) Instant messaging proxy apparatus and method

(76) Inventor: Ficus Kirkpatrick, Palo Alto, CA (US)

Correspondence Address: SADLER, BREEN, MORASCH & COLBY, P.S., 422 W. RIVERSIDE AVE., SUITE 424, SPOKANE, WA, 99201, US

(21) Appl. No.: 10/262,247

(22) Filed: Sep. 30, 2002

(51) Int. Cl. G06F 15/16

(52) U.S. Cl. 709/206

(57) ABSTRACT

A method is described comprising: receiving instant messages from a data processing device in a first instant messaging (“IM”) format; identifying a first IM service to which the instant messages are directed; reformatting the instant messages into a second IM format compatible with the first IM service; and transmitting the instant messages in the second IM format to the first IM service.

### BACKGROUND

1. Field of the Invention

This invention relates generally to the field of data processing systems. More particularly, the invention relates to a proxy server configured to support instant messaging sessions across different, normally incompatible IM services.

2. Description of the Related Art

Instant messaging systems provide for live, text-based chat sessions between two or more users. Unlike e-mail, instant messaging requires that all parties be online at the same time. AOL's Instant Messenger (“AIM®”), Microsoft Network Messenger Service (“MSNMS®”), ICQ® and Yahoo! Messenger® are the major instant messaging services.

Instant messaging clients allows users to maintain a list of contacts, often referred to as a “buddy list” or “contact list.” A user can send instant messages to any of the people in the user's list, as long as those people are online. Sending a message opens up a small window where the user and the user's buddies can type in messages that both can see.

Most of the popular instant messaging programs provide a variety of supplemental features including, for example, Web links (the ability to share links to Websites); image sharing (the ability to view images stored on a buddy's computer; sound sharing (the ability transmit sounds to a buddy); file sharing (the ability to transmit files to a buddy); audio communication (the ability to use the Internet instead of a phone to actually talk with buddies); and information streaming (streaming of real-time or near-real-time information such as stock quotes and news headlines).

Some of the basic principles associated with an instant messaging session will now be described with respect to FIG. 1. In order to establish an instant messaging session, client computers 102 and 104 operated by end users, must initially connect over a network (e.g., the Internet) to an instant messaging service 100. The client computers 102 and 104 typically establish a connection via a dial up line, cable modem connection or digital subscriber line (“DSL”). Alternatively, the client computers 102 or 104 may be connected to the Internet via a local area network (“LAN”) gateway.

In order to communicate with the specified instant messaging service 100, proprietary instant messaging client software must initially be installed on the client computers 102 and 104. For example, if the instant messaging service 100 is AIM, then AOL's proprietary instant messaging client software must be installed. The client software allows the client computers 102 and 104 to communicate with the AIM server using AOL's proprietary instant messaging protocol.

Similarly, other instant messaging services, such as IM service 108, will require different client software installed on client computers 106 and 110. For example, Yahoo's proprietary IM software, which includes built-in support for Yahoo's proprietary IM protocol, must be installed on any client computer that uses Yahoo's IM service. Moreover, the client IM software and associated IM protocols required by each service 100, 108 are not compatible. Client software designed for one service may not be used to connect to a different service.

Once the IM client software is installed, to establish an IM session, the client sends the IM service connection information associated with the client computer (e.g., IP address and port number). The IM service creates a temporary file that contains the connection information for the user and the contacts in the user's buddy list. It then checks to see if any of the contacts in the buddy list are currently logged in.

If the service locates any contacts logged in, it sends the connection information for those contacts back to the client. The IM service also sends the user's connection information to the contacts in the buddy list that are signed on. When the client receives the connection information for a contact in the buddy list, it changes the “status” of that person to “Online.” The user may then click on a name of any contact in the buddy list who is online, opening an IM window in which the user may enter an instant message.

Once the users have signed on to the IM service, all subsequent communication may occur directly between the two clients, as indicated by the “direct link” between clients 102 and 104, and clients 106 and 110. However, in some circumstances, IM communication must continue to occur through the instant messaging service 100. For example, if client 104 is behind a firewall, client 102 may not be permitted to establish an IM session with client 104 directly.

When the user goes “offline” the client sends a message to the IM server to terminate the session. The server then sends a message to the clients of each contact in the user's buddy list who are currently online to indicate that the user has logged off. Finally, the IM server deletes the temporary file that contained the connection information for the client(s).

### SUMMARY

A method is described comprising: receiving instant messages from a data processing device in a first instant messaging (“IM”) format; identifying a first IM service to which the instant messages are directed; reformatting the instant messages into a second IM format compatible with the first IM service; and transmitting the instant messages in the second IM format to the first IM service.

### BRIEF DESCRIPTION OF THE DRAWINGS

A better understanding of the present invention can be obtained from the following detailed description in conjunction with the following drawings, in which:

FIG. 1 illustrates the basic principles associated with instant messaging sessions.

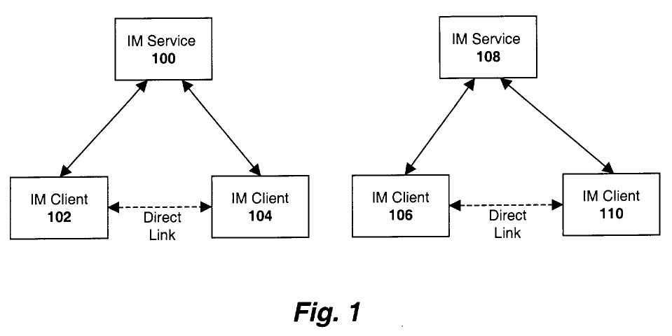

FIG. 2 illustrates an exemplary system on which embodiments of the invention are implemented.

FIG. 3 illustrates a virtual connection maintained with a wireless device according to one embodiment of the invention.

FIG. 4 illustrates an IM proxy implemented within a service according to one embodiment of the invention.

FIG. 5 illustrates a hardware/software architecture employed in one embodiment of the IM proxy of FIG. 4.

### DETAILED DESCRIPTION OF PREFERRED EMBODIMENTS

Described below is a system and method for providing detailed message recipient status information via an electronic messaging service. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

### Embodiments of a Data Processing Service

A variety of portable/wireless data processing devices have been introduced over the past several years. These include wireless personal digital assistants (“PDAs”) such as the Palm® VIIx handheld, cellular phones equipped with data processing capabilities, and, more recently, corporate wireless messaging devices such as the Blackberry™ wireless pager developed by Research In Motion (“RIM”).™

One particular wireless data processing device which operates in conjunction with a data processing service is described in co-pending application entitled NETWORK PORTAL SYSTEM, APPARATUS AND METHOD, Ser. No. 09/714,897, Filed Nov. 15, 2000 (hereinafter “Network Portal Application”), which is assigned to the assignee of the present application and which is incorporated herein by reference. Certain aspects of this data processing device and data processing service will now be described, followed by a detailed description of a system and method for automatically providing user status in an electronic messaging service. It should be noted, however, that the underlying principles of the invention are not limited to the specific service set forth in the Network Portal Application.

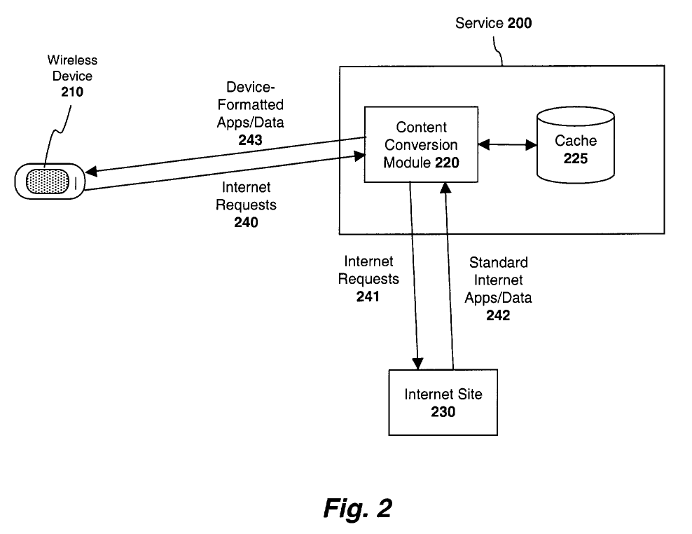

FIG. 2 illustrates one embodiment of a data processing service 200. The data processing service 200 provides a portal through which data processing devices 210 may access content (e.g., Web pages, multimedia content, e-mail, instant messages . . . etc) from external Internet sites 230. In one embodiment, the service 200 converts standard applications and data into a format which each wireless data processing device 210 can properly interpret. Thus, as illustrated in FIG. 2, one embodiment of the service 210 includes a content conversion module 220 for processing requests for Internet content 240. More particularly, the service 200 acts as a proxy for the data processing device 210, forwarding Internet requests 240, 241 to the appropriate Internet site 230 on behalf of the data processing device 210, receiving responses from the Internet site 230 in a standard Internet format (e.g., Web pages with embedded audio/video and graphical content, e-mail messages with attachments, . . . etc), and converting the standard Internet responses 224 into a format which the data processing device 210 can process (e.g., bytecodes as described in the Network Portal Application).

For example, the conversion module 220 may include a hypertext markup language (“HTML”) rendering module (not shown) for interpreting HTML code and downloading any embedded content in the HTML code (e.g., graphics, video, sound, . . . etc) to the service 200. The conversion module 220 may then combine the HTML code and embedded content and generate a set of bytecodes for accurately reproducing the requested content on the data processing device 210. As described above, in one embodiment, the bytecodes may be Java bytecodes/applets. However, the conversion module 220 may generate various other types of interpreted and/or non-interpreted code, depending on the particular type of data processing device 210 being used (e.g., one with an interpreter module or one without).

Because one embodiment of the service 200 maintains an intimate knowledge of the capabilities/configuration of each data processing device 210 (e.g., screen size, graphics/audio capabilities, available memory, processing power, user preferences, . . . etc) it can reconstruct the requested Internet content accurately, while at the same time minimizing the bandwidth required to transmit the content to the device 210. For example, the conversion module 220 may perform pre-scaling and color depth adjustments to the requested content so that it will be rendered properly within the data processing device's 210's display. In making these calculations, the conversion may factor in the memory and processing power available on the data processing device 210. In addition, the conversion module 220 may compress the requested content using a variety of compression techniques, and thereby preserve network bandwidth.

### Automatic User Status

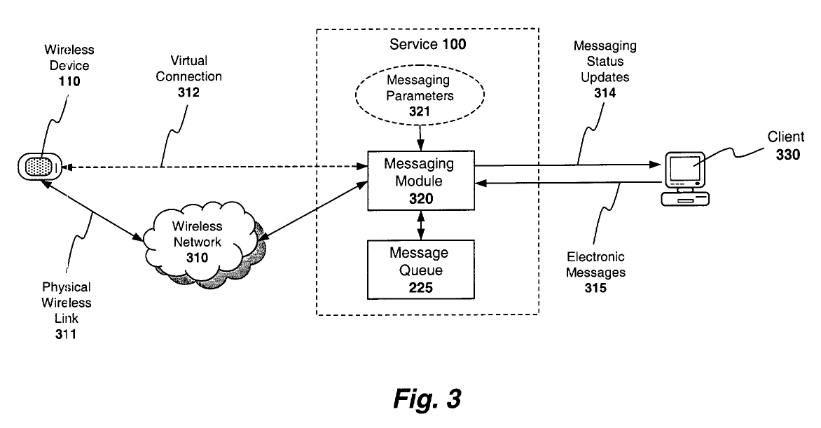

One embodiment of the service 100, illustrated in FIG. 3, is comprised of an electronic messaging module 320 which coordinates message passing between the wireless device 110 and other wireless and non-wireless data processing devices (e.g., such as client 330 illustrated in FIG. 3). The messaging module 320 operates in accordance with a set of user-selectable or service-selectable messaging parameters 321.

When a user of the wireless device 110 is logged in to the service 100 to receive instant messages, the messaging module 320 forwards instant messages from other clients 330 to the wireless device 110 via the wireless network 310. Conversely, the wireless messaging module 320 forwards instant messages transmitted from the wireless device 110 to message recipients logged in on the various clients 330. The wireless messaging module 220 coordinates instant messaging sessions with any number of logged-in users. The other clients 330 with which the wireless device 110 communicates may be any type of data processing devices capable of sending and receiving instant messages over a network (e.g., other wireless devices, desktop/notebook personal computers communicatively coupled to a local area network or a digital subscriber line, personal digital assistants, . . . etc).

Due to the inherently mobile nature of the wireless device 110, it may periodically come in and out of contact with the wireless network 310 (i.e., the wireless link 111 may not be completely reliable). For example, if the user enters a tunnel, elevator or otherwise travels through an out-of-coverage area, the wireless device 110 may be temporarily incapable of sending or receiving instant messages. In prior instant messaging systems, the message sender would simply receive a message indicating that the user was offline, or would receive no indication whatsoever.

However, in one embodiment of the invention, the messaging module 320 maintains a continual virtual connection 312 to the wireless device 110, even when the device 110 temporarily moves out of contact of the wireless network 310. While the wireless device 110 is out of coverage, the messaging module 320 stores any messages addressed to the wireless device 110 in a temporary message queue 325. As soon as the service 100 detects that the wireless device 110 is back online, the messages in the message queue 325 are forwarded to the wireless device 110. In one embodiment, the wireless device 110 includes a similar message queue for temporarily storing outgoing instant messages until communication with the network 310 is reestablished.

In one embodiment, because the service 100 continually tracks the current status of the device 110, the messaging module 320 may provide detailed user status information to the various message senders. For example, when the device is temporarily out of contact, rather than merely sending a message that the device 110 is “offline,” or sending no indication whatsoever, the messaging module 320 transmits an indication that the device has temporarily moved out of contact. Similarly, if the device has been out of contact for an extended period of time, the messaging module 320 may log the user off of the messaging session and transmit an indication that the device 110 is offline.

### Instant Messaging Proxy

As mentioned above, each instant messaging service uses a different, incompatible instant messaging (“IM”) protocol. As such, in order to communicate with users on different IM services, the client for each IM service, which includes built-in support for the service-specific IM protocol, must typically be installed on the user's data processing device.

One embodiment of the invention supports communication across multiple IM services by translating between the IM protocol used by the wireless device and the service-specific IM protocol used by each individual IM service. As a result, users may communicate over multiple IM services using a single client interface.

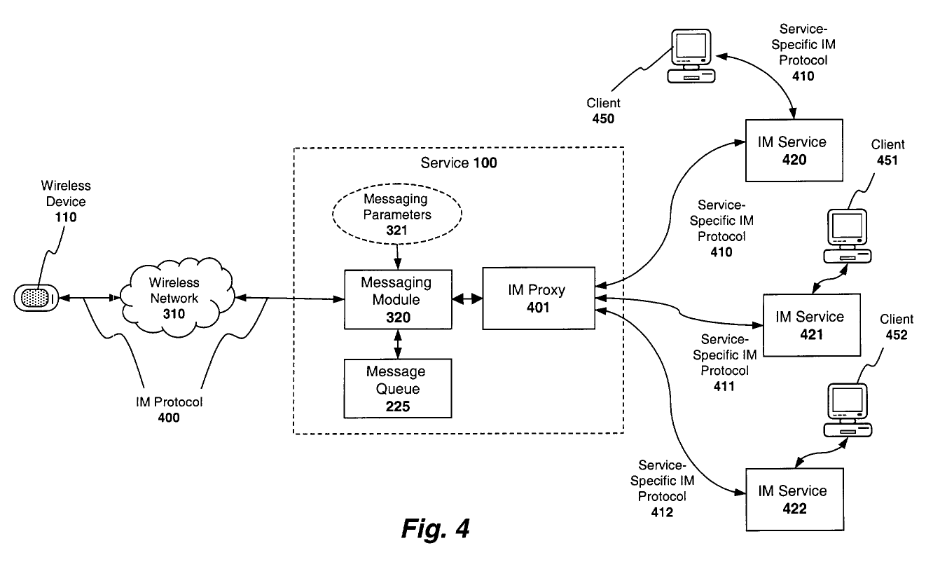

As illustrated in FIG. 4, in one embodiment an IM proxy server 401 is configured within the service 100 to support communication between each of the different IM services 420-421 and the wireless device 110. More specifically, the IM proxy server 401 translates between the IM protocol 400 employed on the wireless device 110, and the service-specific protocols 410-412 employed between the proxy server 401 and each of the IM services 420-422, respectively. Thus, a user may open IM accounts on different IM services and maintain concurrent IM sessions on each of the different IM services using the same client software. For example, IM service 420 may be AOL's Instant Messenger service (“AIM®”); IM service 421 may be Microsoft Network Messenger Service (“MSNMS®”) and IM service 422 may be the Yahoo! Messenger® service. The user may open an IM session with client 450 on AIM 420 while at the same time maintaining IM sessions with client 421 on the MSNMS service 421 and client 422 on the Yahoo! Messenger service 422.

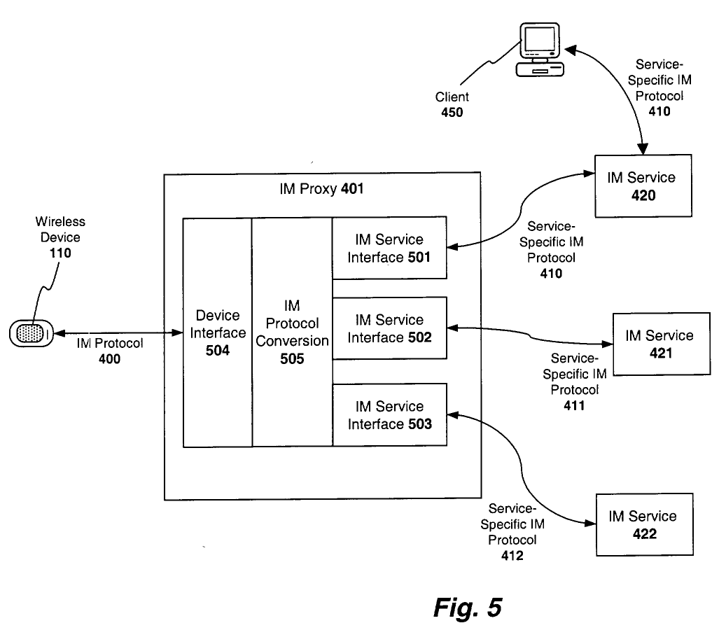

As illustrated in FIG. 5, the IM proxy 401 is comprised generally if a device interface 504 which supports the IM functions employed by the wireless device 110 and a set of IM service interfaces 501-503 which support the IM functions employed by each of the different IM services 420-422, respectively. An IM protocol conversion module 505 converts between the IM functions/protocols supported by the device interface 504 and the IM functions/protocols supported by each of the IM service interfaces 501-503. For example, if IM service 420 is the AIM service, then IM service interface 501 communicates using AOL's proprietary instant messaging protocol 410 and associated IM functions (e.g., file transfers functions, encryption functions, . . . etc). Because the protocol conversion module 505 and each of the service-specific interfaces 501-503 are implemented within the service 100, conversion between the data processing device's IM protocol 400 and the service-specific protocols 410-412 occurs transparently to the end user.

In converting between the IM service protocols and the IM protocol employed by the data processing device, the IM protocol conversion module 505 may convert various types of data objects. For example, if a particular IM service supports the transmission of graphical images (e.g., JPEG files) or sounds (e.g., WAV files), then the IM protocol conversion module 505 converts the transmitted images/sounds into a format which the data processing device 110 can process and render. Similarly, if the data processing device employs 110 file formats which are incompatible with the various IM services 420-422 such as, for example, proprietary imaging and/or audio formats, then the IM protocol conversion module 505 converts the files into a format which the IM services 420-422, and/or the clients communicatively coupled thereto, can process (e.g., standard JPEG and WAV files). A virtually unlimited number of different file types may be converted by the IM protocol conversion module 505 while still complying with the underlying principles of the invention.

Various wireless network types may be employed to support communication between the wireless device 110 and the service 100 including, by way of example but not limitation, packet-based networks such as Cellular Digital Packet Data (“CDPD”), the General Packet Radio Service (“GPRS”) and Mobitex. It should be noted, however, that the underlying principles of the invention are not limited to any particular type of wireless network 310.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, while the embodiments described above focus on an instant messaging implementation, the underlying principles of the invention may be implemented using various alternate messaging protocols. Accordingly, the scope and spirit of the invention should be judged in terms of the claims which follow.

1. An instant messaging proxy system comprising:
a wireless data processing device interface to support instant messaging (IM) communications with a wireless data processing device over a wireless network using a first IM protocol;
a first IM service interface to support IM communications with a first IM service using a second IM protocol;
a conversion module to translate between the first IM protocol and the second IM protocol, thereby allowing the wireless data processing device to establish an IM session with the first IM service, and to convert files which are incompatible with the wireless data processing device into a format that the wireless data processing device can process, wherein the files are converted and delivered in real-time consistent with communication during an active IM session; and
a messaging module to maintain a virtual connection to the wireless data processing device, the messaging module including a message queue to store IM communications addressed to the wireless data processing device when the wireless data processing device is not in communicable contact with the wireless network, wherein:
if the wireless data processing device comes into communicable contact with the wireless network within a predetermined amount of time from last being communicable contact with the wireless network, then IM communications stored in the message queue are transferred to the wireless data processing device; and
if the wireless data processing device does not come into communicable contact with the wireless network within a predetermined amount of time from last being in communicable contact with the wireless network, then the IM proxy system logs off the wireless data processing device from the IM session;
wherein the IM proxy receives outgoing instant messages from the wireless data processing device when communication with the wireless network is reestablished, the outgoing instant messages having been stored in an outgoing message queue on the wireless data processing device when the wireless data processing device was not in communicable contact with the wireless network.

2. The IM proxy system as in claim 1 further comprising:
a second IM service interface to support IM communications with a second IM service using a third IM protocol, the third IM protocol being incompatible with the second IM protocol, wherein the conversion module translates between the first IM protocol and the third IM protocol, thereby allowing the data processing device to establish an IM session with the second IM service.

3. The IM proxy system as in claim 2 wherein the IM proxy server support multiple concurrent IM sessions between the wireless data processing device and the first and second IM services.

4. (canceled)

5. The IM proxy system as in claim 3 wherein the conversion module converts files which are incompatible with the first IM service into a format that the first IM service, or clients communicatively coupled thereto, can process.

6. (canceled)

7. A system comprising:
a wireless data processing device having an instant messaging (IM) client installed thereon; and
a proxy server communicatively coupled between the wireless data processing device over a wireless network and one or more IM services, the proxy server to translate between a first IM protocol employed on one of the IM services and a second IM protocol employed on the wireless data processing device when an IM session exists between the IM service and the wireless data processing device,
wherein the proxy server comprises data conversion logic which converts files received from the one or more IM services which are incompatible with the wireless data processing device into a format that the wireless data processing device can process, wherein the files are converted and delivered in real-time consistent with communication during an active IM session,
wherein the proxy server maintains a virtual connection to the wireless data processing device, wherein if the wireless data processing device becomes communicably uncoupled from the wireless network, the proxy server stores a wireless communication from one or more IM services addressed to the wireless data processing device in a message queue, wherein:
if the wireless data processing device becomes communicably coupled to the wireless network within a predetermined amount of time from becoming communicably uncoupled from the wireless network, then the proxy server transfers the stored wireless communication in the message queue to the wireless data processing device; and
if the wireless data processing device does not become communicably coupled to the wireless network within a predetermined amount of time from becoming communicably uncoupled from the wireless network, then the proxy server logs off the wireless electronic device from the IM session;
wherein if the wireless data processing device reestablishes communicable contact with the wireless network, the IM proxy receives outgoing instant messages from the wireless data processing device that have been stored in an outgoing message queue on the wireless data processing device when the wireless data processing device was communicably uncoupled from the wireless network.

8. The system as in claim 7 wherein the proxy server translates between a third IM protocol employed on a second one of the IM services and the second IM protocol employed on the wireless data processing device.

9. (canceled)

10. The system as in claim 8 wherein the data conversion logic converts files which are incompatible with the one or more IM services into formats that the IM services, or clients communicatively coupled thereto, can process.

11. (canceled)

12. The system as in claim 7 wherein the IM proxy server and the one or more IM services are communicatively coupled over the Internet.

13. The system as in claim 7 wherein the data processing device is a cellular telephone with data processing capabilities.

14. A method comprising:
receiving instant messaging stat from a wireless data processing device in a first instant messaging (IM) format, the wireless data processing device communicably connected over a wireless network;
identifying a first IM service to which the instant messaging data is directed;
reformatting the instant messaging stat into a second IM format compatible with the first IM service;
transmitting the instant messaging data in the second IM format to the first IM service during an IM session;
receiving instant messaging data from the first IM service in the second IM format;
identifying the wireless data processing device to which the instant messaging data is directed;
reformatting the instant messaging data into the first IM format;
converting files received from the one or more IM services which are incompatible with the wireless data processing device into a format that the wireless data processing device can process, where in the files are converted and delivered in real-time consistent with communication during an active IM session;
if the wireless data processing device is communicably connected to the wireless network within a predetermined amount of time from being communicably disconnected from the wireless network, then;
storing the instant messaging data in the first IM format in a message queue when the wireless data processing device is not communicably connected to the wireless network;
transferring the stored instant message data in the message queue to the wireless data processing device when the wireless data processing device is then communicably connected to the wireless network; and
receiving outgoing instant messages from the wireless data processing device that have been stored in a message queue on the wireless data processing device when the wireless data processing device was communicably uncoupled from the wireless network; and
if the wireless data processing device is not communicably connected to the wireless network within a predetermined amount of time from being communicably disconnected from the wireless network, then logging off the wireless data processing device from the IM session,
wherein if the IM client reestablishes communicable contact with the wireless network, the IM proxy server receives outgoing instant messages from the IM client that have been stored in an outgoing message queue on the IM client when the IM client was communicably uncoupled from the wireless network.

15. (canceled)

16. The method as in claim 14 further comprising:
receiving additional instant messaging data from the data processing device in the first IM format;
identifying a second IM service to which the additional instant messaging stat is directed;
reformatting the additional instant messaging data into a third IM format compatible with the second IM service; and
transmitting the additional instant messaging data in the third IM format to the second IM service.

17. The method as in claim 14 wherein the instant messaging data comprises a new instant message.

18. The method as in claim 14 wherein the instant messaging data comprises a data file.

19. The method as in claim 18 wherein the data file comprises a graphical image.

20. (canceled)

21. The method as in claim 14 wherein transmitting comprises transmitting the instant messaging data to the first IM service over the Internet.

22. A method comprising:
communicatively coupling an instant messaging (IM) proxy server between an IM client and an IM service, the IM proxy server to translate between a first IM protocol employed by the IM client and a second IM protocol employed by the IM service during an IM session between the IM client and the IM service, converting files received from the one or more IM services which are incompatible with the IM Client into a format that the IM Client can process, wherein the files are converted and delivered in real-time consistent with communication during an active IM session, and wherein:
the IM proxy server is communicably coupled to the IM client over a wireless network; and
the IM proxy server maintains a virtual connection the IM client, the IM proxy server including a message queue to store IM communications addressed to the IM client when the IM client is not communicable contact with the wireless network, wherein:
if the IM client comes into communicable contact with the wireless network within a predetermined amount of time from last being in communicable contact with the wireless network, the IM communications stored in the message queue are transferred to the wireless data processing device; and
if the IM client does not come into communicable contact with the wireless network within a predetermined amount of time from last being in communicable contact with the wireless network, then the IM proxy system logs off the IM client from the IM session
wherein if the IM client reestablishes communicable contact with the wireless network, the IM proxy server receives outgoing instant messages from the IM client that have been stored in an outgoing message queue on the IM client when the IM client was communicably uncoupled from the wireless network.

23. (canceled)

24. The method as in claim 22 wherein the IM client is communicatively coupled to the IM service over the Internet.

25. the IM proxy system as in claim 1 wherein the conversion module is further configured to generate a set of bytecodes for accurately reproducing content on the wireless data processing device.

26. The IM proxy system as in claim 1 wherein the conversion module is further configured to compress the files, thereby preserving network bandwidth.

27. The system as in claim 7 wherein the data conversion logic is further configured to generate a set of bytecodes for accurately reproducing content on the wireless data processing device.

28. The system as in claim 7 wherein the data conversion logic is further configured to compress the files, thereby preserving network bandwidth.

29. The method as in claim 14 further comprising generating a set of bytecodes for accurately reproducing content on the wireless data processing device.

30. The method as in claim 14 further comprising compressing the files, thereby preserving network bandwidth.

31. The method as in claim 22 further comprising generating a set of bytecodes for accurately reproducing content on the wireless data processing device.
